(19) United States
(12) Patent Application Publication
(10) Pub. No.: US 2006/0004121 A1
(43) Pub. Date: Jan. 5, 2006

(54) Polymer-brush modified fillers for composites

(76) Inventors: Xingzhe Ding, Aurora, CO (US); Jeffrey W. Stansbury, Aurora, CO (US)

Correspondence Address: GREENBERG TRAURIG, LLP, 1200 SEVENTEENTH STREET, SUITE 2400, DENVER, CO, 80202, US

(21) Appl. No.: 11/077,829

(22) Filed: Mar. 10, 2005

Related U.S. Application Data
(60) Provisional application No. 60/552,340, filed on Mar. 10, 2004.

(51) Int. Cl. C08K 3/00

(52) U.S. Cl. 523/115

(57) ABSTRACT

The present invention relates to polymer-brush modified fillers and methods, compositions and processes of modification of fillers and more particularly fillers useful in dental materials and other compositions that exhibit higher mechanical strength, longer hydrolytic stability, lower polymerization stress and improved wear and abrasion resistance. The present invention provides a method for making a polymer-brush modified filler comprising: providing a filler material; silanizing the filler material with a silane; and reacting the silanized filler with a telechelic oligomer. The present invention further provides a method of preparing a shaped dental prosthetic device for use in a human mouth comprising: dispensing a mixture having at least one monomer and a polymer brush modified filler; shaping the mixture; and photopolymerizing the mixture.

This application claims priority to U.S. Application Ser. No. 60/552,340 filed 10 Mar. 2004.

### STATEMENT REGARDING FEDERALLY SPONSORED RESEARCH OR DEVELOPMENT

The invention was sponsored by NIH/NIDCR (National Institute for Dental and Craniofacial Research) # 1 R01 DE 14227-01 and the government has certain rights to this invention.

### FIELD OF THE INVENTION

The present invention relates generally to polymer-brush modified fillers and methods, compositions and processes of modification of fillers and more particularly fillers useful in dental materials and other compositions that exhibit higher mechanical strength, longer hydrolytic stability, lower polymerization stress and improved wear and abrasion resistance.

### BACKGROUND DESCRIPTION OF THE RELATED ART

Currently, commercial photoactivated dental restorative resins are based on dimethacrylates and the reaction mechanism is through chain-growth free radical polymerization. Existing dimethacrylate systems are popular for fillings and other dental prostheses because of their esthetic merit and “cure-on-command” feature.

Such dental restorative materials are often mixed with 45 to 85 wt % silanized filler compounds such as barium, strontium, zirconia silicate and/or amorphous silica to match the color and opacity to a particular use or tooth. The filler is typically in the form of particles with a size ranging from 0.01 to 20.0 micrometers.

The photoactivated restorative materials are often sold in separate syringes or single-does capsules of different shades. If provided in a syringe, the user dispenses (by pressing a plunger or turning a screw adapted plunger on the syringe) the necessary amount of restorative material from the syringe onto a suitable mixing surface. Then the material placed directly into the cavity, mold, or location of use. If provided as a single-dose capsule, the capsule is placed into a dispensing device that can dispense the material directly into the cavity, mold, etc. After the restorative material is placed, it is photopolymerized or cured by exposing the restorative material to the appropriate light source. The resulting cured polymer may then be finished or polished as necessary with appropriate tools. Such dental restoratives can be used for direct anterior and posterior restorations, core build-ups, splinting and indirect restorations including inlays, onlays and veneers.

Cured polymer composites consist of two or more regions with different structure and/or composition and discernible interfaces; in the case of dental filling composites, a mixture of an organic methacrylate-based resin matrix and an inorganic filler or fillers. An ideal dental composite would have the following characteristics: low polymerization shrinkage stress; high/stable mechanical strength; excellent resistance to oral environmental conditions; good biocompatibility; and minimal wear. In dental composites, many different silicates have been used as fillers for their mechanical reinforcing effect and to reduce overall polymerization shrinkage, coefficient of thermal expansion, water sorption, staining, etc. The mechanical properties and hydrolytic stability of composites can be improved by improving adhesion of inorganic fillers particles to polymer matrix. γ-Methacryloxypropyltrimethoxysilane (γ-MPS) has been widely used as a coupling agent because it provides covalent bonds between the filler and resin matrix. The composite resin containing γ-MPS treated filler showed improved bending strength.

Problems with current silanization technology, however may be as described in Liu Q, Ding J, Chambers D E, Debnath S, Wunder S, Baran G. Filler-coupling agent-matrix interactions in silica/polymethacrylate composites. Journal of Biomedical Materials Research 2001;57:384-393, which can be described as follows: 1) adsorption of γ-MPS in the surface of filler is not strong enough because the treatment process is usually at room temperature; 2) the loosely adsorbed silane could desorb from silica and be incorporated into the polymer matrix through copolymerization with monomer; 3) treatment at high temperature may destroy part of the C═C bonds; 4) the linkage between filler and polymer matrix is short and rigid. Moreover, the γ-MPS treated filler containing dental resin has a multilayered highly condensed silane inter-phase that limits mobility of the silane methacrylate as described elsewhere (Halvorson R H, Erickson R L, Davidson C L. The effect of filler and silane content on conversion of resin-based composite. Dental Materials 2003;19:327-333). In addition, most of the methacrylate functionality within the silane layer is in a non-reactive environment. All of these disadvantages will reduce the numbers of covalent bonds between filler and resin matrix, and then lower the mechanical properties and hydrolytic stability of the dental composites.

### SUMMARY OF THE INVENTION

The present invention provides a method for making a polymer-brush modified filler comprising: providing a filler material; silanizing the filler material with a silane; and reacting the silanized filler with a telechelic oligomer.

The raw filler is selected from the group comprising borosilicate, barium aluminosilicate glasses, glass powder, silica, silica powder, titanium silicates, zirconium silicates, barium oxide, quartz; ammoniated montmorillonite clay, de-ammoniated montmorillonite clay, calcium phosphate, hydroxyapatite alumina, zirconia, tantalum oxide, tin oxide, titania, aluminum nitride, silicon nitride, titanium nitride, aluminum carbide, silicon carbide, titanium carbide; polymer fiber, glass fiber, whisper fibers, carbon nanotubes and their modified forms by silicate. In a preferred embodiment, the silica and glass powder are particles have a particle diameter in the range of 0.001 μm to 100 μm.

The silane is selected from the group comprising functional silanes, a combination of functional silanes and non-functional silanes. The silanes for silanization of the silica and the glass powder are selected from the group comprising silanes with functional groups, mixtures of silanes with functional groups, combinations of silanes with functional groups, silanes with non-functional groups, hydrolyzed silanes and pre-polymerized silanes. Silanes with functional groups may have at least one of amine, anhydride, epoxy, hydroxyl, and sulfur functional groups.

The telechelic oligomer (telechelic polymer, telechelic prepolymer) is a functional ended chemical compound is selected from the group consisting of oligomer, polymer, and prepolymer. In one aspect, the functional group ended chemical compound has a linear or branched structure, a molecular weight in the range of 300 to 50,000, with 2-18 average number of functionalities. The telechelic oligomer may have one or more of the following functionalities as the end group: (meth)acrylate, epoxide, hydroxyl, —COOH, —NH₂, —N(CH₃)H, isocyanate.

The present invention further provides a method of preparing a shaped dental prosthetic device for use in a human mouth comprising: dispensing a mixture having at least one monomer and a polymer-brush modified filler; shaping the mixture; and photopolymerizing the mixture.

### A BRIEF DESCRIPTION OF THE DRAWINGS

FIG. 1 provides a diagram of one aspect of the present invention: a silane is applied to the surface of an inorganic dental particulate filler; telechelic oligomers are applied to form a polymer-brush surface; polymerizable dental monomers are added; and the system is cured by photopolymerization to form a shaped dental prosthetic material or device.

FIG. 2 shows a series of representative functionalized (amino, hydroxyl or thiol) silane compounds.

FIG. 3 shows a reaction of an amino-functionalized silane with a filler and further reaction with a di-epoxide polymer to form an epoxide functionalized filler.

FIG. 4 shows reaction of an epoxide-functionalized filler with (meth)acrylic acid under triethylbenzyl ammonium chloride as catalyst to form a (meth)acryloyl-terminated polymer-brush.

FIG. 5 shows an alternative reaction of an epoxide-functionalized filler where one or more —OH functionalities along the polymer chain is reacted with isocyanatoethyl methacrylate.

FIG. 6 shows attachment of the oligomer or pre-polymer with di- or multi-carboxylic acids to the amino-functionalized silane treated filler, and then further reaction with 2-hydroxyethyl methacrylate to form the (meth)acrylate-terminated polymer-brush.

FIG. 7 shows a modification of amino-functionalized silanated fillers with a di-(meth)acrylate prepolymer by Michael reaction.

FIG. 8 shows reaction of a thiol-functionalized silane treated filler with a di-(meth)acrylate.

FIG. 9 shows an isocyanate-functionalized polyurethane coupled to an amino-functionalized filler and further reaction with 2-hydroxyethyl methacrylate (HEMA) to provide a terminal methacrylate functionality that can subsequently copolymerize with the dental resin.

FIG. 10 shows an isocyanate-functionalized polyurethane coupled to a hydroxy-functionalized filler and further reaction with 2-hydroxyethyl methacrylate (HEMA) to provide a terminal methacrylate functionality that can subsequently copolymerize with the dental resin.

FIG. 11 shows FTIR spectra of pure OX-50, OX-50 modified by 3-methylaminopropyl)trimethoxysilane and the amine-modified OX-50 further reacted with the epoxy resin.

FIG. 12 shows the FTIR spectra of pure OX-50, γ-AMPS modified OX-50 and bisphenol A ethyoxylate diacrylate (BAED) attached via the 3-methylaminopropyl)trimethoxysilane modified OX-50.

FIG. 13 shows mechanical properties of photocured composites based on bis-GMA/TEGDMA (7/3 wt) with 30% of epoxy polymer brush modified OX-50 filler. The molecular weight range of the epoxy chains varies from 348 to 6100 g/mol. A γ-MPS control was included for comparison. Specimens were stored in water 24 h prior to testing in a 3-point bending.

FIG. 14 (A) shows SEM photographs of the fractured surface of composites prepared by using pure OX-50.

FIG. 14 (B) shows SEM photographs of the fractured surface of composites prepared by using γ-MPS treated OX-50.

FIG. 14 (C) shows SEM photographs of the fractured surface of composites prepared by using polymer-brush modified OX-50.

### DETAILED DESCRIPTION

The present invention relates generally to polymer-brush modified fillers for use in dental compositions. Polymer-brushes refer to an assembly of polymer chains, which are tethered by one end to a surface or an interface as described previously (Zhao B, Brittain W J. Polymer brushes: surface-immobilized macromolecules. Progress in Polymer Science 2000;25:677-710) which is hereby incorporated by reference. Generally, there are two ways to fabricate polymer brushes: physisorption and covalent attachment. For polymer physisorption, block copolymers adsorb onto a suitable substrate with one block interacting strongly with the surface and other block interacting weakly with the substrate. There are two approaches for covalent attachment, which can be accomplished, by either “grafting to” or “grafting from.” The “grafting to” approach refers to preformed, end-functionalized polymers reacting with a suitable substrate surface under appropriate conditions to form a tethered polymer brush. The “grafting from” approach refers to the initiators that are immobilized onto the surface followed by in situ surface initiated polymerization to generate tethered polymers. In general, by the “grafting to” approach, the polymer brush has a low grafting density; while by the “grafting from” approach, the polymer brush has a high grafting density.

The interface between a solid surface and a cross-linked polymer can be considerably strengthened by the addition of chains that are tethered by one end to the solid surface (polymer brushes). At high grafting densities, however, these coupling chains may segregate and the adhesion may drop considerably. The use of a chemical attached graft polymer brush with controlled spatial geometry and chemical functionality enables a significant increase in the strength and fracture energy of the interphase, to the point of cohesive fracture of the substrate, or that of an adjacent medium such as adhesives, paints or elastomers.

The particle-matrix interface has an effect on the mechanical properties of the end product. Introducing a thin rubbery interlayer between filler and a matrix can modify the interface. Usually, silica particles are used as a hard filler, methacrylate-butadiene-styrene rubber (MBS) as a soft filler. The fracture toughness of the epoxy composite improves remarkably by using both silica and MBS filler. Studies on the silane treatment effects on glass/resin interfacial shear strengths have used amine-terminated poly-(butadiene/acrylonitrile) rubber attached to the glass fiber surface via glycidoxypropyltrimethoxy-silane molecules. The studies show rubber treatment of the fiber provided improvement in interfacial strength.

One embodiment of the present invention modifies the filler with covalently attaching reactive (meth)acrylate groups through a polymer-brush (spacer linkage) that can be significantly varied in terms of hydrophobicity, flexibility, miscibility and length and then to provide a dental filling resin composition or other composite materials having higher filler loading, greater hydrolytic stability, increased wear resistance, superior mechanical properties and reduced polymerization shrinkage and stress.

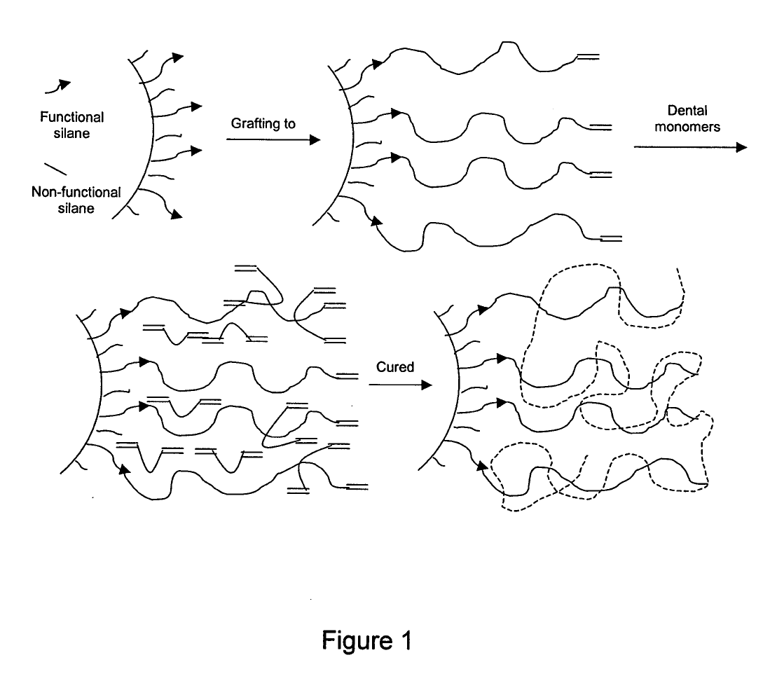

In order to develop the above embodiment, the present inventors have made extensive and intensive investigation. First silane treated fillers were produced with controlled functional coupling chain density by choosing suitable silanes containing both functional and non-functional groups at wide range temperature, solvents, which leads to an improved hydrolytic stability. The functional groups silanes are those silanes with amine, anhydride, epoxy, hydroxyl, or sulfur group. Secondly end-functional polymers are synthesized or chosen to have different lengths and flexibilities of the chain, with (meth)acrylate groups on the end of polymer brushes, and to provide good miscibility with dental monomers. Next, by reaction of the end-functional polymers with silane treated filler with the “grafting to” approach, a functional polymer-brush modified filler results. The grafting density is relatively low and the dental monomers can easily diffuse through the coating polymer brushes. The modified filler particles can be homogeneously dispersed in the resin matrix and form stable interpenetrating polymer networks after photopolymerization. Finally, by using the modified fillers, and mixing them with other dental monomers and necessary additives, dental composites are formulated, fabricated, and characterized having improved mechanical properties, wear-resistance, water hydrolytic stability and reduced polymerization shrinkage and stress. FIG. 1 provides a general overview of an approach in the present invention. In the first step, a functional silane (or a mixture of a functional and nonfunctional silane) is applied to the surface of an inorganic particulate filler. There are no polymerizable groups present at this stage, so the silanation procedure can be driven to obtain maximized coverage and stability. In the second step, telechelic oligomers (linear or branched polymers with terminal functional groups) are reacted to form polymer brush surface structures. As indicated in the third stage, these polymeric species are expected to enhance compatibility between dental monomers and the filler as composite pastes. Finally, the composite is photopolymerized to couple the polymer brush into the crosslinked resin matrix. Also to be examined are polymer brush structures without polymerizable end groups, where simple physical entanglement between the filler bound polymer and the matrix polymeric network are responsible for the coupling between filler and matrix.

A wide range of filler materials can be modified. The raw filler materials can be (1) borosilicate, barium aluminosilicate glasses, glass powder, silica, silica powder, titanium or zirconium silicates, barium oxide, quartz; (2) ammoniated or de-ammoniated montmorillonite clay, calcium phosphate, hydroxyapatite, alumina, zirconia, tantalum oxide, tin oxide, titania, aluminum nitride, silicon nitride, titanium nitride, aluminum carbide, silicon carbide and titanium carbide; and (3) polymer fiber, glass fiber, whisper fibers, carbon nanotubes, or their modified forms by silicate, and any combination of above fillers. The sizes of these fillers range from 0.001 μm to 100 μm, i.e., from microfillers to macrofillers.

One embodiment will provide for the design of a coupling system between silane and a glass filler using functional silanes with or without other non-functional silanes to modify the glass surface so as to produce a controlled coupling chain density. Important features in the silanization process are the extent of surface coverage, interface structure and the stability of the surface treated layer.

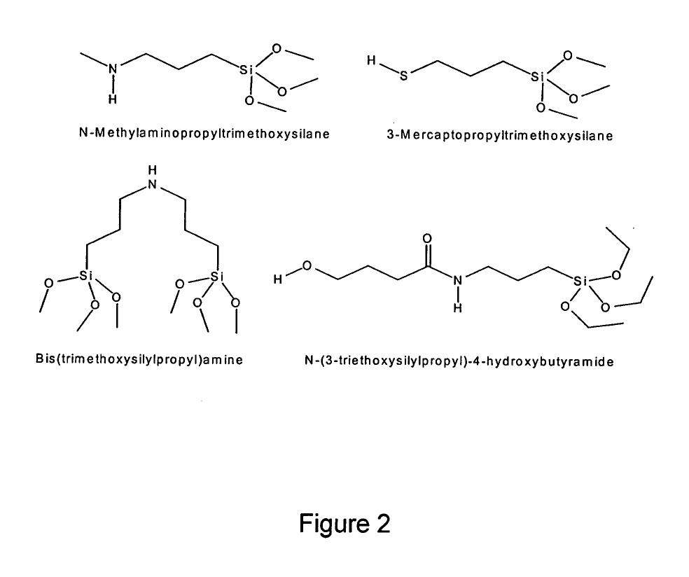

First, FIG. 2 shows, a select series of functionalized (amino, anhydride, epoxy, hydroxyl or thiol) silane compounds without C═C double bonds. A quantity of interest in relation to these silane compounds is the range of temperatures in which the silanization process can be carried out. The surface micro-structure attachment of silane has been analyzed for silanization procedures conducted at room temperature and temperatures up to 125° C. in suitable solvents. Both small particle glass (0.10 to 100 μm average particle diameter) and fumed quartz microfiller (0.005-0.10 μm average diameter) can be used.

A silane may be defined as an organic molecule comprising a silicon atom. Functional silanes further comprise an amine group, anhydride group, epoxy group or a sulfur group; and non-functional silanes lack these groups. The amine group may be a primary or a secondary amine; with either one or two carbon atoms bonded to the nitrogen atom, respectively. The anhydride group may be symmetrical or non-symmetrical, and has a structure (—C(O)OC(O)—). The epoxy, or epoxide, group is a tricyclic heterocyle with two carbon atoms and one oxygen atom forming the three-membered ring. The sulfur group (—SH), may also be called a thiol group; a molecule containing a thiol group may be called a mercaptan. Silanes used in one embodiment included functional silanes and non-functional silanes. Non-functional silane was used with functional silanes to control the surface density of functional groups.

The term “alkyl”, “aliphatic” or “aliphatic group” as used herein means a straight-chain or branched C₁₋₁₂ hydrocarbon chain that is completely saturated or that contains one or more units of unsaturation, or a monocyclic C₃₋₈ hydrocarbon or bicyclic C₈₋₁₂ hydrocarbon that is completely saturated or that contains one or more units of unsaturation, but which is not aromatic (also referred to herein as “carbocycle” or “cycloalkyl”), that has a single point of attachment to the rest of the molecule wherein any individual ring in said bicyclic ring system has 3-7 members. For example, suitable alkyl groups include, but are not limited to, linear or branched or alkyl, alkenyl, alkynyl groups and hybrids thereof such as (cycloalkyl)alkyl, (cycloalkenyl)alkyl or (cycloalkyl)alkenyl.

The terms “alkoxy,” “hydroxyalkyl,” “alkoxyalkyl” and “alkoxycarbonyl,” used alone or as part of a larger moiety include both straight and branched chains containing one to twelve carbon atoms. The terms “alkenyl” and “alkynyl” used alone or as part of a larger moiety shall include both straight and branched chains containing two to twelve carbon atoms.

The term “heteroatom” means nitrogen, oxygen, or sulfur and includes any oxidized form of nitrogen and sulfur, and the quaternized form of any basic nitrogen.

The term “aryl” used alone or in combination with other terms, refers to monocyclic, bicyclic or tricyclic carbocyclic ring systems having a total of five to fourteen ring members, wherein at least one ring in the system is aromatic and wherein each ring in the system contains 3 to 8 ring members. The term “aryl” may be used interchangeably with the term “aryl ring”. The term “aralkyl” refers to an alkyl group substituted by an aryl. The term “aralkoxy” refers to an alkoxy group substituted by an aryl.

The following are some examples of functional and non-functional silanes:

Silanes with amine functional group:

Monoamine functional silanes, such as:

3-aminopropyltriethoxysilane; 3-aminopropyltrimethoxysilane; 4-aminobutyltriethoxysilane; 4-aminobutyltrimethoxysilane; aminophenyltrinethoxysilane (para, meta or their mixtures); 3-aminopropyltris(methoxyethoxyethoxy)silane; 3-(m-aminophenoxy)propyltrimethoxysilane); aminopropylsilanetriol; 3-aminopropylmethyldiethoxysilane; 3-aminopropyldiisopropylethoxysilane; 3-aminopropyldimethylethylethoxysilane;

Diamine functional silanes, such as:

N-(2-aminoethyl)-3-aminopropyltrimethoxysilane; N-(2-aminoethyl)-3-aminopropyltriethoxysilane; N-(6-aminohexyl)aminomethyltriethoxysilane; N-(6-aminohexyl)aminomethyltrimethoxysilane; N-(6-aminohexyl)aminopropyltriethoxysilane; N-(6-aminohexyl)aminopropyltrimethoxysilane; N-(2-aminoethyl)-11-aminoundecyltrimethoxysilane; (aminoethylaminoethyl)phenethyltrimethoxysilane; N-3-[amino(polypropylenoxy)]aminopropyltrimethoxysilane; N-(2-aminoethyl)-3-aminopropylsilanetriol; N-(2-aminoethyl)-3-aminopropylmethyldimethoxysilane; N-(2-aminoethyl)3-aminoisobutylmethyldimethoxysilane; (aminoethylamino)-3-isobutyldimethylmethoxysilane;

Triamine functional silane, such as:

(3-trimethoxysilylpropyl)diethylenetriamine;

Secondary amine functional silanes, such as:

n-butylaminopropyltriethoxysilane; n-butylaminopropyltrimethoxysilane; N-methylaminopropyltriethoxysilane; N-methylaminopropyltrimethoxysilane; N-phenylaminopropyltrimethoxysilane; N-phenylaminopropyltriethoxysilane; N-cyclohexylaminopropyltrimethoxysilane; N-methylaminopropylmethyldimethoxysilane;

Dipodal amine functional silanes, such as:

bis(trimethoxysilylpropyl)amine; bis[(3-trimethoxysilyl)propyl]-ethylenediamine; bis[methyldiethoxysilylpropyl)amine;

Silane with an anhydride functional group:

3-(triethoxysilyl)propylsuccinic anhydride;

Silanes with an epoxy functional group:

2-(3,4-Epoxycyclohexyl)ethyltriethoxysilane; 2-(3,4-epoxycyclohexyl)ehtyltrimethoxysilane; (3-glycidoxypropyl)trimethoxysilane; 3-glycidoxypropyl)triethoxysilane; (3-glycidoxypropyl)methyldimethoxysilane; (3-glycidoxypropyl)methyldiethoxysilane; (3-glycidoxypropyl)dimethylethoxysilane; 5,6-epoxyhexyltriethoxysilane;

Silanes with a hydroxyl functional group:

bis(2-hydroxyethyl)-3-aminopropyltriethoxysilane; N-(hydroxyethyl)-N-methylaminopropyltrimethoxysilane; hydroxymethyltriethoxysilane; N-triethoxysilylpropyl)-O-polyethylene oxide urethane; N-(3-triethoxysilylpropyl)-4-hydroxybutyramide;

Silanes with sulfur functional groups:

3-mercaptopropyltrimethoxysilane; 3-mercaptopropyltriethoxysilane; 3-mercaptopropylmethyldimethoxysilane;

Silanes with non-functional groups:

acetoxymethyltrimethoxysilane; acetoxymethyltriethoxysilane; acetoxypropylltrimethoxysilane; benzoyloxypropyltrimethoxysilane; benzyltriethoxysilane; bis(triethoxysilyl)ethane; 1,9-bis(triethoxysilyl)nonane; bis(triwthoxysilyl)octane; bis(trimethoxysilyl)ethane; 1,4-bis(trimethoxysilylethyl)benzene; bis(trimethoxysilyl)hexane; n-butyltrimethoxysilane; n-butyltriethoxysilane; cyclohexylethyldimethoxysilane; cyclohexylmethyldimethoxysilane; cyclohexyltrimethoxysilane; cyclopentyltrimethoxysilanen-decyltriethoxysilane; diethyldiethoxysilane; diisobutyldimethoxysilane; diisopropyldimethoxysilane; dimethyldiethoxysilane; dimethyldimethoxysilane; diphenyldiethoxysilane; diphenyldimethoxysilane; dodecylmethyldiethoxysilane; dodecyltriethoxysilane; ethyltriacetoxysilane; ethyltriethoxysilane; ethyltrimethoxysilane; (heptadecafluoro-1,1,2,2-tetra-hydrodecyl)triethoxysilane; hexadecyltrimethoxysilane; hexyltrimethoxysilane; hexyltriethoxysilane; isobutylmethyldimethoxysilane; isobutyltriethoxysilane; isobutyltrimethoxysilane; isooctyltriethoxysilane; isooctyltrimethoxysilane; 2-[methoxy(polyethyleneoxy)propyl]trimethoxysilane; 2-[methoxy(polyethyleneoxy)propyl]triethoxysilane; 3-methoxypropyltriethoxysilane; 3-methoxypropyltrimethoxysilane; methyltriacetoxysilane; methyltriethoxysilane; methyltrimethoxysilane; methyltri-n-propoxysilane; n-octadecylmethyldiethoxysilane; n-octadecyltriethoxysilane; n-octadecyltrimethoxysilane; n-octylmethyldiethoxysilane; n-octylmethyldimethoxysilane; n-octyltriethoxysilane; n-octyltrimethoxysilane; pentafluorophenylpropyltriethoxysilane; pentafluorophenylpropyltrimethoxysilane; pentyltriethoxysilane; pentyltrimethoxysilane; phenethyltrimethoxysilane; phenylmethyldiethoxysilane; phenylmethyldimethoxysilane; phenyltriethoxysilane; phenyltrimethoxysilane; n-propyltriethoxysilane; p-tolyltrimethoxysilane; n-propyltriethoxysilane; n-propyltrimethoxysilane; (tridecafluoro-1,1,2,2-tetrahydro-octyl)triethoxysilane; (3-triethoxysilylpropyl)-t-butylcarbamate; triethoxysilylpropylethylcarbamate; (3,3,3-trifluoropropyl)triethoxysilane; (3,3,3-trifluoropropyl)trimethoxysilane. The functional silanes with amine, anhydride, epoxy and sulfur groups; and non-functional silanes, are not limited to the above examples. Moreover, the hydrolyzed or pre-polymerized of any above silane or their mixtures may be applied, for example, some commercial hydrolyzed or pre-polymerized silanes from Dow Corning Company such as Dow Corning® Z-6106, Dow Corning® Z-6121, Dow Corning® Z-6137, Dow Corning® Z-6430, Dow Corning® 520, SYL-OFF® 297. The similar hydrolyzed or pre-polymerized silanes from other companies are also available and suitable in alternative embodiments of the present invention.

In one embodiment, the two amine-containing silanes, N-methylaminopropyltrimethoxysilane and bis(trimethoxysilylpropyl)amine, used for the modification of the filler, the hydrolytic stability of the composite with latter silane can be improved since the dipodal silane has significant impact on substrate bonding, hydrolytic stability and mechanical strength of many composites systems. The resistance to hydrolysis of dipodal silanes (with the potential to form up to six bonds to a substrate/interphase) has been estimated as an order of magnitude greater than conventional coupling agents with the ability to form at most three bonds. The other silanes with thiol, anhydride, epoxy, or hydroxyl functional groups also can provide efficiently covered, alternatively functionalized filler surfaces. These will serve as intermediates for further reaction with acrylate, isocyanate, COOH or epoxy-based oligomeric or prepolymeric species, either with or without a terminal poymerizable group.

Depending on the silane structure and its wetting ability, methyltrimethoxysilane or other non-functional silane, together with other functional silanes, can control the surface density of functional groups. In a limited comparison, a more hydrophobic dodecyl silane is substituted for the methyl silane as the non-functionalized component. The percentage of non-functional silane used can be varied between 0 and 80 wt %. Preferably the percentage of non-functional silane is in the range of 0 to 60 wt %.

For the silanization process, normally, water, alcohol, various organic solvents or their mixtures can be used as the solvent. For example, alcohol solvents can be methyl alcohol, ethyl alcohol, isopropyl alcohol, propyl alcohol, butanol, sec-butyl alcohol, tert-butyl alcohol, and any combination of above solvent, and their mixtures with water, etc. Other organic solvents, such as hydrocarbon solvents, pentane, hexane, cyclohexane, heptane, octane, benzene, toluene, xylene and acetone, butanone, 2-pentanone, and 3-pentanone are also suitable for the silanizaton process. The solvents for this process are not limited to the above lists. Depending on the properties of the silanes and solvents used in the silanization process, acetic acid or other acids can be added to adjust the pH of the solution. The use of acetic acid maintains the pH in the range of 3.5 to 9. For example, when silanes with amino functional group and alcohol, water, or the mixture of alcohol and water solvents are used for the silanization, acetic acid, or other acids, should be added to keep the solution preferably in the range of pH 4-8. When silanes with amino functional group and other non-alcohol solvents such as hydrocarbon solvents, pentane, hexane, cyclohexane, heptane, octane, benzene, toluene, xylene are used for silanization, the acids can be added, but without the addition of these acids, the silanization also is suitable for the present patent.

The concentration of silane in solution is varied according to the surface area of the filler. Usually, silane addition level will be in the range of 0.1-30 wt % of the filler. Preferably the range will be 1.0-20 wt %. The treatment time varies from 0.5h to 24 h and preferably from 2 hours to 24 hours and the silanization temperature varies from room temperature (approximately 20° C.) to 150° C. Preferably the temperature is maintained in a range from room temperature to 125° C. The fillers are treated under such condition to make sure that the silane can be tightly attached to the filler and the hydrolytic stability can be great improved compared with the γ-MPS treatment as a positive control and the untreated filler as the negative control. The extended reaction times at significantly elevated temperatures produce more efficient silane coverage and stability compared with the typically lower temperature, shorter reactions involving γ-MPS-treated fillers. At the elevated reaction temperatures and extended reaction times, the proportion of surviving methacrylate functionality from γ-MPS is diminished.

The first step of one embodiment is to identify a silanization protocol in terms of reaction time and temperature that produces effective surface coverage with controlled deposition of accessible NH, COOH, OH or SH functional groups that can then be used in a secondary reaction step to attach polymeric species.

Modified fillers selected from first step can be converted to functionalized polymer brushes for developing novel materials with excellent compatibility toward dental monomers. The surface-tethered chains either have terminal (meth)acrylate functional groups allowing direct copolymerization with dental resin matrix or the polymeric chains lack a polymerizable group and rely instead on physical interactions with the matrix to provide the desired filler-matrix coupling. In one embodiment, the “grafting to” approach is used to form the polymer brush modified fillers. This involves attachment of preformed oligomeric or polymeric species to the filler through reaction with the pre-existing functional groups with controlled surface density. While there is some degree of dual attachment of the telechelic oligomers looping back and reacting on the same surface, this is minimal for the following reasons: a) an excess of the telechelic oligomer or polymer will be used with the unbound excess removed from the filler by ultrasonic washing or centrifugation; b) a good solvent for the polymer used during the reaction assures that the polymer remains in an extended rather than collapsed state; and c) the length of the prepolymers is such that it is unlikely to have both ends within a reaction proximity of the filler surface while the excess free polymer is competing for the functional silane reactive sites. The heterogeneous reaction involving the functionalized silane modified filler and the solution-based end-functionalized oligomer/polymer avoids any covalent connection between separate filler particles.

It is important that these polymeric chains have good compatibility with dental monomers. By controlling the polymer chain composition, attachment density and length, a desirable intimate association between the polymeric coupling agent and the monomeric resin phase is sought such that a strong semi-interpenetrating network can be formed upon polymerization of the crosslinked matrix, whether or not the interphase contains polymerizable groups. In the case of coupling agents with terminal polymerizable groups, which should display enhanced mobility while the matrix is in its monomeric state, improved copolymerization with the matrix is expected, compared with the limited methacrylate mobility and resin compatibility of the γ-MPS interfacial zone. This polymer brush modified filler approach has been devised to improve bonding and local load transfer between resin and glass filler, which could yield better mechanical properties and decreased polymerization stress in the composite with respect to conventional materials.

The reaction with the silanized filler is with a functional group-ended chemical compound such as oligomers and prepolymers. There are a number of readily available commercial telechelic oligomers or polymers with well-characterized structures and molecular weights. From these many choices of end-group functionalities, the use of oligomeric or polymeric di- or multi-(meth)acrylates, di- or multi-carboxylic acids, di- or multi-epoxies, di- or polyisocyanates, and diols or polyols are primary. The average number of functionalities of the oligomers or prepolymers can be ranged from 2 to 18. In addition, the synthesis and use of oligomeric or polymeric with any combination of above functionality, i.e., oligomer or polymer with both (meth)acrylate and isocyanate as end-group, are also necessary and important. These oligomers or pre-polymers can also be synthesized via radical/living radical polymerization, cationic/living cationic polymerization, anionic polymerization, condensation polymerization, etc. The oligomers or prepolymers can be polyurethane, epoxy resin, polybutadiene, siloxane, polyether, polyester, poly(styrene-co-butadiene), poly[(meth)acrylate] and the copolymer of poly[(meth)acrylate]. There are also several commercially available telechelic oligomers or prepolymers. The following are some examples of commercial products:

Some oligomers or prepolymers have di- or multi-(metha)acrylates as end-groups. These oligomers or pre-polymers can be attached to fillers via aminosilanes with Michael Reaction.

Several commercial epoxy acrylate oligomers or prepolymers resins are available. Such as: XZ 92551.00, XZ 92478.00 (Dow Chemical); CN series of epoxy acrylate from Sartomer such as CN104, CN 115, CN 116, CN 117, CN 118, CN 119, CN120, CN 121, CN120J90, CN124, CN UVE 151, CN 2204, etc.; UV-91, UV-92, UV-95BA30 etc. (InChem Corp).

Other oligomers or prepolymers with di- or multi-(meth)acrylates as end-groups include epoxy methacrylate resin (Dow Chemicals, Sartomer, Surface Specialties, Bomar Specialties Co); aliphatic urethane acrylate (Sartomer, Fairad Technology, Bayer, Surface Specialities, Bomar Specialties Co); aromatic urethane acrylate(Sartomer, Bayer, Surface Specialties); urethane methacrylate (Sartomer, Surface Specialties, Bomar Specialties Co); polybutadiene acrylate oilgomer (Sartomer); chlorinated polyester acrylate oilgomer (Sartomer,); polyester acrylate oilgomer (Sartomer, Bayer, Surface Specialties, Bomar Specialties Co); silicone acrylate oligomer (Sartomer, Gelest), etc. These oligomers or prepolymers can be attached to the filler surfaces via aminosilanes by Michael Reaction.

Oligomers or pre-polymers are available with di- or multi-carboxylic acids as end-groups are available from Sartomer.

Epoxy oligomer or pre-polymer resins (with di- or multi-epoxides as end-groups) are available from different companies such as Dow Chemicals, Aldrich, etc.). These oligomers or pre-polymers can be attached to fillers via aminosilanes or anhydride functional silanes.

Urethane oligomers or prepolymers with di- or polyisocyanates as end-groups are commercial available from many companies including Desmodur (Bayer); Coronate (Nippon Polyurethane); Duranate (Asahi); Burnoch (Dai Nippon Ink); Trixene (Baxenden). These oligomers or pre-polymers can be attached to fillers via silanes containing thiol-, hydroxyl- or amino-functional group.

Several oligomers or prepolymers containing diols or polyols end groups are commercially available. These prepolymer can be attached to filler via silanes containing anhydride or isocyanates functional groups.

The functional oligomers or pre-polymers are not limited to the above products. The corresponding acrylate oligomers or prepolymers made by other companies are also suitable.

The above oligomers or pre-polymers can be used for the further treatment of the intermediate silanated surfaces in order to produce polymer brushes. As example, a description of several systems follows. These examples are not intended to limit the scope of the invention in any way.

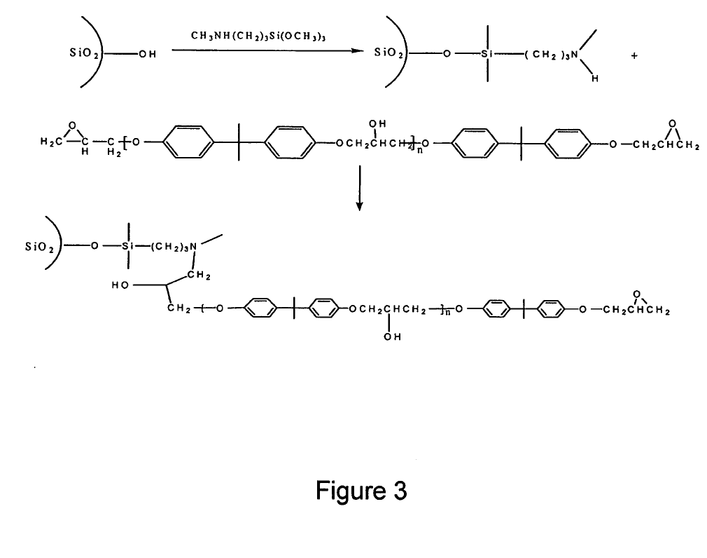

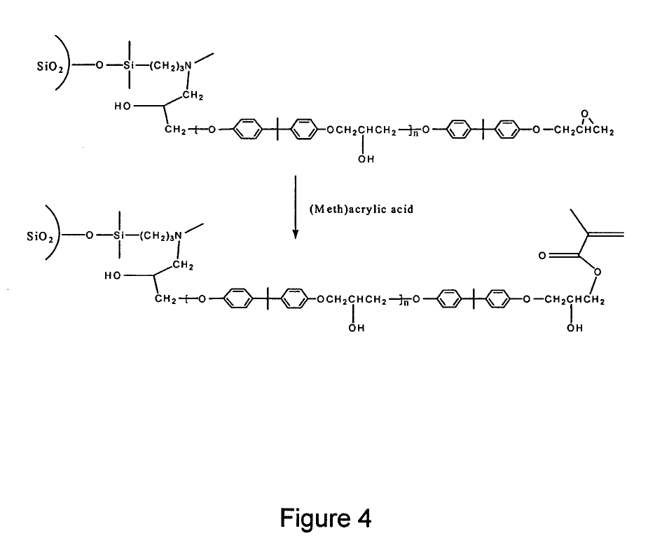

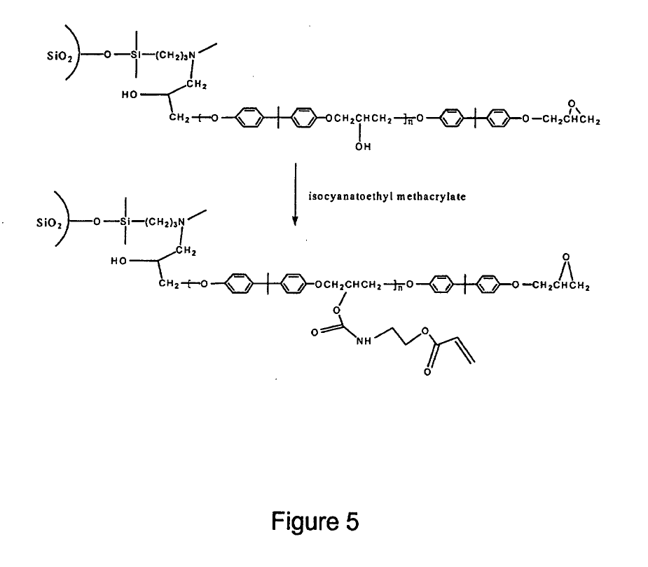

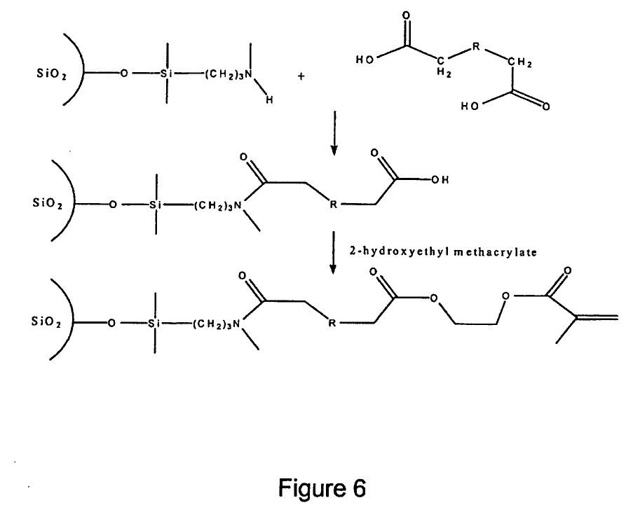

First, a reaction of amino-functionalized filler with oligomers or prepolymers with di- or multi-epoxides-end or with —COOH-ends is illustrated. An aromatic, di-, or multi-epoxide or di-, or multi-COOH, mono-, di-, multi-hydroxyl and —COOH end oligomers will be coupled to the amino-functionalized silane treated filler. An example of an amino-functionalized filler with an epoxide is shown in FIG. 3. These modified fillers, which lack any free radically polymerizable end groups, can then be used to further study coupling agents that physically interact and entangle with dental resins during polymerization. In addition, the oligomers and prepolymers may have —NH₂, di- or multi-NH₂ and —N(Me)H as end groups. Alternatively, the epoxy-terminal group can be opened by reaction with (meth)acrylic acid under triethylbenzyl ammonium chloride as catalyst to form the (meth)acryloyl-terminated polymer-brush, as shown in FIG. 4. Once again, there is a series of commercially available di- multi-epoxide-terminated oligomers, which range in molecular weight from approximately 350 to 6100 (Aldrich, n=0.1-25; FIG. 3) that are used to prepare the polymer-brush modified fillers. By this approach, relatively stiff epoxy-based brushes can be prepared and compared with the di-, or multi-acrylate-functionalized polyurethane brushes obtained from in other approach. As an alternative to the (meth)acrylate-terminated polymer brush structure shown in FIG. 4, reactive coupling agents are prepared where the repeated OH functionality along the polymer chain is partially reacted with isocyanatoethyl methacrylate (As shown in FIG. 5). This gives us a second method to introduce resin matrix-copolymerizable groups and to increase the density of these potential sites for covalent attachment to the polymerized resin matrix. The oligomer or pre-polymer with di- or multi-carboxylic acids can be easily attached to the amino-functionalized silane treated filler, and then further to form the (meth)acrylate-terminated polymer-brush, as shown in FIG. 6.

Second, a modification of amino-functionalized silanated fillers with di- multi-(meth)acrylate prepolymer may be achieved by Michael reaction. Amines containing active hydrogen can react with activated double bonds such as (meth)acrylates. This reaction is commonly known as a Michael addition. Michael reactions have been used for the synthesis of functional (meth)acrylate-terminated monomers, which has the potential applicability as a matrix resin for dental composites. Here the amino silane intermediate materials obtained in first step are modified to form (meth)acrylate-terminated functional fillers that range from surfaces with relatively small pendant molecules (simple diacrylate monomers) up to polymer brushes based on the Michael addition of oligomers or polymers. Michael reaction conditions are quite mild and can be carried out in solution at room temperature for several hours to several days. The reaction time can be shortened by increasing the reaction temperature. The ratio of di-, or multi-acrylates to surface-bound amine can be varied to identify reaction conditions that maximize both amine consumption and acrylate retention in the washed filler, which would be an indication of efficient single reaction of the di- or multi-acrylate tethered to the surface. This reaction can be characterized by quantitative mid-IR and near IR spectroscopy.

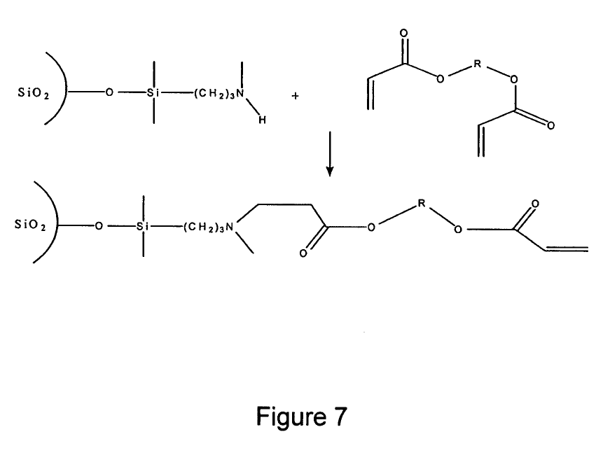

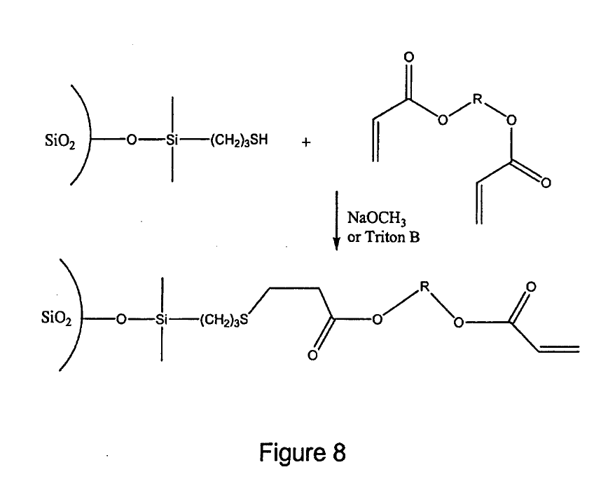

The R group in FIG. 7 can be an aliphatic or aromatic repeating group that is either flexible or rigid, such as polyether, polyester, polyurethane, epoxy oligomer, siloxane, poly(styrene-co-butadiene), poly(meth)acrylate, the copolymer of poly(meth)acrylate or polybutadiene. These polymers or prepolymers are linear or branched, and the number of (meth)acrylate per polymer or prepolymer are ranged from 2 to 18. The butadiene example is of interest because the residual unsaturation all along the connecting group could participate in the eventual resin matrix polymerization as well as the copolymerization with the terminal acrylate groups. These oligomers or polymers with a wide range of molecular weights (100's to 10,000) are commercially available. Preferably the molecular weight of the oligomers and polymers will be in the range of 300 to 50,000. With the polyurethane-brush modified filler, the urethane-based hydrogen bonding interactions between pendant chains as well as with dental monomers, such as Bis-GMA and urethane dimethacrylate (UDMA), are important and can be examined by near-IR spectroscopy, since the inorganic filler is essentially transparent over the near-IR region of the spectrum. In a reaction analogous to the Michael addition, the thiol-functionalized silane treated filler can also be reacted with prepolymers containing di- or multi-(meth)acrylates through a thiol-ene addition reaction mechanism (as shown in FIG. 8).

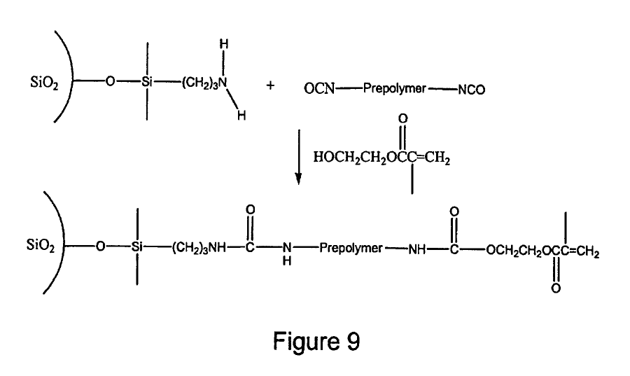

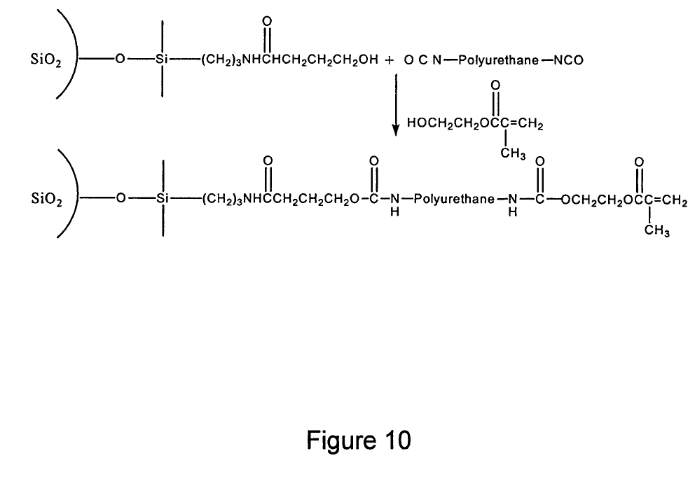

Third, is the reaction of modified fillers containing hydroxy-, amino- or thiol-functional groups with isocyanate-terminated oligomer or prepolymer. Here a series of isocyanate-terminated polyurethanes can act as coupling agents. Polyurethanes are available in a wide range of molecular weights and structures from the simple polymerization reaction between small molecule diols or polyols and diisocyanates. The molecular weight is controlled by the proportions of the two reactants and if the diisocyanate reactant is used in excess of the diol, an isocyanate-terminated polyurethane or prepolymer is produced. These functionalized polyurethanes will be coupled to the filler via the amino—(as shown in FIG. 9) or hydroxyl groups controllably introduced by the N-(3-triethoxysilylpropyl)-4-hydroxybutyramide silanization step (FIG. 10). After washing away excess unbound prepolymer, the remaining terminal isocyanate groups will be reacted with 2-hydroxyethyl methacrylate (HEMA), as shown in FIGS. 9 and 10, to provide the terminal methacrylate functionality that can subsequently copolymerize with the dental resin.

The further treatments of the intermediate silanated surfaces with functional oligomer or prepolymer to produce polymer brushes are not limited to the above processes. These further treatments can be conducted in various solvents and at a wide range of temperature. Based on different reaction, the solvents can be alcohol, ketone, hydrocarbon, aromatics, toluene, xylene, N,N-dimethyl formamide (DMF), dimethyl sulfoxide (DMSO), ether, tetrahydrofuran, etc., or any of combination of the above solvents. The reaction temperature can be from room temperature to 150° C. The reaction time can be from 0.5 to 150 hours.

The polymer-brush modified fillers, in one embodiment, are formulated as visible light curable dental materials. The compatibility between filler and resin and the polymerized composite materials are significant characteristics. The interphase of the polymer matrix and the filler plays a key role in the properties and performance of dental composites. By changing the contents and chemical components of polymer-brushes, the wettability, hydrolytic stability, adhesion, and wear-resistance of the filler with the polymer matrix can be favorably improved.

In addition, another important factor to consider is the compatibility between the polymer-brush modified filler and dental monomers. A model resin (BisGMA:TEGMA; wt ratio=70:30) and the maximum amount of the modified filler that can be incorporated are determined and compared with the control materials based on an γ-MPS silanized filler. A mortar and pestle are used to mechanically blend the filler and resin with the maximum filler loading evidenced by heterogeneity in the paste. Higher filler load will lead to lower volumetric shrinkage and potentially lower shrinkage stress. Low filler loading can also be examined so that fractured cured composite specimens can be evaluated by SEM to assess the distribution of filler in the matrix (homogeneous or agglomerated). In addition, some simple consistency evaluations of the composite pastes will be made at a fixed filler loading level.

The photopolymerization process with the composites containing the modified fillers can be by real-time near-IR to get information on both polymerization kinetics and final conversion, which will affect the final mechanical properties of dental materials. Conversion is defined as the loss of the methacrylate double bond, or loss of another functional group, upon polymerization. By altering the interfacial region between filler and matrix resin, the overall polymerization conversion may be enhanced. This aspect will be apparent when the kinetics and conversion in composites based on polymer brush modified fillers that lack a polymerizable group are compared with composites prepared with unsilanized filler. The efficiency of the coupling agent copolymerization with the matrix monomers can be conducted using the high surface area nanofiller to maximize the surface bound double bond intensity.

The aggregation of filler modifies composite stiffness only slightly, but strength and impact resistance are highly dependent on structure, with both decreasing as the extent of aggregation increases. The mode of failure initiation also depends on particle size with filler debonding as the dominant mechanism in composites containing large particles, while cracks are initiated inside aggregates formed by small particles. By applying the polymer-brush modified filler, the clustering of the microfiller particles can be avoided and the dispersion of the filler into the resin matrix will be improved. In addition, a more compatible, gradient-like interface between filler and polymer matrix improves the coupling of these very different phases. Mechanical properties of flexural strength (3-point bending) and fracture toughness (single edge notched beam specimens) are evaluated for all the experimental and control materials. Scanning electron microscopy on fractured surfaces can be examined and associated with the observed mechanical properties of the composites.

The potential of polymer-brush modified filler to reduce the polymerization shrinkage and shrinkage stress effects in dental composites is also of importance. There are methods to monitor either shrinkage or stress evolution while simultaneously obtaining real time conversion data by near-IR spectroscopy during photopolymerization. The materials developed here provide reduced composite polymerization shrinkage through several separate modes: a) greater filler loading due to improved compatibility between filler and resin, b) potential expansion of the relatively low modulus interfacial region during polymerization, and c) release of an infiltrated monomer from the interfacial zone during polymerization. Since the polymer brush interfacial region can potentially act as an internal stress absorber, the polymerization stress can be reduced. Of additional importance is the difference created by significantly different surface areas in small particle filler and nanofiller.

The experimental data indicates that polymer brush modified fillers can produce composites with better mechanical properties compared to γ-MPS treated fillers. The polymer brushes with terminal copolymerizable groups offer significantly improved properties. There are a tremendous variety of structures that can be considered here as polymer brush modified fillers. From these data, it can be demonstrated that the polymer brush surface treatment offers significant advantages compared with the traditional coupling agent approach. It is widely recognized that the coupling agent has a dramatic effect on the clinical performance of a composite material. Also, through this relatively simple modification to dental composites, those novel materials capable of higher filler loading, higher monomer conversion, lower polymerization stress, improved filler/matrix coupling and meaningfully improved properties may evolve.

The following examples are presented to demonstrate the silanization, “grafting to” process for the polymer-brush, fabrication, characterization and testing of materials in accordance with the present invention. These examples are not intended to limit the scope of the invention in any way.

### EXAMPLES

All starting materials are commercially available. IR spectra are recorded on Nicolet 670 FT-IR spectrometer. Polymerization stress is recorded on an ADA Health Foundation Tensometer.

Example 1-8 are the description of silanization process.

Example 1. Silanization of OX-50 fumed quartz microfiller (with 0.04 μm average diameter) with N-methylaminopropyltrimethoxysilane in toluene. OX-50 (30 g) and toluene (600 ml) were added to a 1000 ml flask (with a condenser). The reactor contents were heated to a slight reflux for two hours to remove the tiny water in the reaction system. Then 5 ml N-methylaminopropyltrimethoxysilane (Gelest) was added to the flask and the reaction mixture was then stirred at reflux (115° C.) for 12 hours. After that, it was cooled to room temperature and filtered, washed by toluene three times. Then it was dried at 80° C. for 24 hours.

Example 2. Silanization of OX-50 fumed quartz microfiller (with 0.04 μm average diameter) with N-methylaminopropyltrimethoxysilane in ethyl alcohol/water (90/10 vol). OX-50 (60 g), ethyl alcohol (540 ml), and de-ionized water (60 ml) were added to a 1000 ml flask. Under stirring, 2 ml acetic acid was added to the mixture at room temperature. After 10 minutes, 8 ml N-methylaminopropyltrimethoxysilane was dropped to the reaction mixture over 20 minutes. During the addition of N-methylaminopropyltrimethoxysilane, acetic acid was also dropped to keep the solution in the range of pH=6.0-7.0. After addition of silane and acetic acid, the reaction mixture was stirred at room temperature for another 12 hours. Then the reaction mixture was filtered. The silanized OX-50 was washed by acetone three times and then dried at 80° C. for 24 hours.

Example 3. Silanization of OX-50 fumed quartz microfiller (with 0.04 μm average diameter) with aminopropyltrimethoxysilane in toluene. This example is similar to example 1. In this process, 5 ml aminopropyltrimethoxysilane (Gelest) was instead of 5 ml N-methylaminopropyltrimethoxysilane in example 1.

Example 4. Silanization of OX-50 fumed quartz microfiller (with 0.04 μm average diameter) with bis(trimethoxysilylpropyl)amine in toluene. This example is similar to example 1. In this process, 5 ml bis(trimethoxysilylpropyl)amine (Gelest) was instead of 5 ml N-methylaminopropyltrimethoxysilane in example 1.

Example 5. Silanization of OX-50 fumed quartz microfiller (with 0.04 μm average diameter) with N-(3-triethoxysilylpropyl)-4-hydroxybutyramide in toluene. This example is similar to example 1. In this process, 5 ml N-(3-triethoxysilylpropyl)-4-hydroxybutyramide (Gelest) was instead of 5 ml N-methylaminopropyltrimethoxysilane in example 1.

Example 6. Silanization of E-3000 Glass (barium borosilicate glass with 0.7 μm average diameter) with N-methylaminopropyltrimethoxysilane in toluene. This example is similar to example 1. In this process, 100 g E-3000 Glass (with 0.7 μm average diameter) and 10 ml N-methylaminopropyltrimethoxysilane were instead of 30 g OX-50 (with 0.04 μm average diameter) and 5 ml N-methylaminopropyltrimethoxysilane in example 1.

Example 7. Silanization of Quartz (with 5.0 μm average diameter) with N-methylaminopropyltrimethoxysilane in toluene. This example is similar to example 1. In this process, 100 g Quartz (with 5.0 μm average diameter) and 10 ml N-methylaminopropyltrimethoxysilane were instead of 30 g OX-50 (with 0.04 μm average diameter) and 5 ml N-methylaminopropyltrimethoxysilane in example 1.

Example 8. Silanization of Quartz (with 5.0 μm average diameter) with N-methylaminopropyltrimethoxysilane in ethyl alcohol/water (90/10 vol). This example is similar to example 2. In this process, 100 g Quartz (with 5.0 μm average diameter) and 10 ml N-methylaminopropyltrimethoxysilane were instead of 60 g OX-50 (with 0.04 μm average diameter) and 8 ml N-methylaminopropyltrimethoxysilane in example 2.

Example 9-25 are the description of polymer-brush (spacer linkage) modified filler by “grafting to” approach.

Example 9. 75 ml N,N-dimethyl formamide (DMF) and 2.0 g epoxy (Aldrich), i.e., poly(bisphenol A-co-epichlorohydrin), glycidyl end-capped with molecular weight of 348 were added to a 100 ml flask. After epoxy was dissolved at 65° C. under stirring, 10 g N-methylaminopropyltrimethoxysilane modified OX-50 (as described in example 1) was added, and the reaction mixture was kept at 65° C. for 48 hours. Then the mixture was filtered. The solid was washed by acetone for three times and dried under vacuum.

Example 10. This example is similar to example 9. In this process, 2.0 g epoxy with molecular weight of 1750 was used.

Example 11. This example is similar to example 9. In this process, 2.0 g epoxy with molecular weight of 4000 was used.

Example 12. This example is similar to example 11. In this process, 10.0 g N-methylaminopropyltrimethoxysilane modified OX-50 (as described in example 2) was used.

Example 13. This example is similar to example 11. In this process, 10.0 g aminopropyltrimethoxysilane modified OX-50 (as described in example 3) was used.

Example 14. This example is similar to example 11. In this process, 10.0 g bis(trimethoxysilylpropyl)amine modified OX-50 (as described in example 4) was used.

Example 15. This example is similar to example 9. In this process, 2.0 g epoxy with molecular weight of 6100 was used.

Example 16. 75 ml dried tetrahydrofuran and 10.0 g example 10 modified OX-50 were added to a 100 ml flask. 2.0 g isocyanatoethyl methacrylate was dropped during 30 minutes at room temperature. Then two drops of dibutyltin dilaurate catalyst was added and the reaction mixture was kept at room temperature for 12 hours. Then the mixture was filtered. The solid was washed by acetone for three times and dried under vacuum.

Example 17. 75 ml ethyl alcohol and 3.0 g bisphenol A ethyoxylate (1EO/phenol) diacrylate (Aldrich) were added to a 100 ml flask. After dissolved at room temperature under stirring, 10 g N-methylaminopropyltrimethoxysilane modified OX-50 (as described in example 1) was added, and the reaction mixture was kept at room temperature for one week. Then the mixture was filtered. The solid was washed by acetone for three times and dried under vacuum.

Example 18. This example is similar to example 17. In this process, 3.0 g urethane acryalte CN 2900 (Sartomer) was used instead of 3.0 g bisphenol A ethyoxylate (1EO/phenol) diacrylate.

Example 19. This example is similar to example 17. In this process, 3.0 g urethane acryalte CN 929 (Sartomer) was used instead of 3.0 g bisphenol A ethyoxylate (1EO/phenol) diacrylate.

Example 20. 75 ml dried tetradrofuran and 10.0 g N-(3-triethoxysilylpropyl)-4-hydroxybutyramide modified OX-50 (as described in example 5) were added to a 100 ml flask. 2.0 g isocyanatoethyl methacrylate was dropped during 30 minutes at room temperature. Then two drops of dibutyltin dilaurate catalyst was added and the reaction mixture was kept at room temperature for 12 hours. Then the mixture was filtered. The solid was washed by acetone for three times and dried under vacuum.

Example 21. This example is similar to example 18. In this process, 10.0 g N-methylaminopropyltrimethoxysilane modified E-3000 Glass (with 0.7 μm average diameter) (as described in example 6) was used instead of 10.0 g N-methylaminopropyltrimethoxysilane modified OX-50 (with 0.04 μm average diameter).

Example 22. This example is similar to example 21. In this process, 3.0 g urethane acrylate CN929 was used instead of 3.0 g CN2900.

Example 23. This example is similar to example 18. In this process, 10.0 g N-methylaminopropyltrimethoxysilane modified Quartz (with 5.0 μm average diameter) (as described in example 7) was used instead of 10.0 g N-methylaminopropyltrimethoxysilane modified OX-50 (with 0.04 μm average diameter).

Example 24. This example is similar to example 23. In this process, 3.0 g urethane acrylate CN929 was used instead of 3.0 g CN2900.

Example 25. This example is similar to example 24. In this process, 10.0 g N-methylaminopropyltrimethoxysilane modified Quartz (with 5.0 μm average diameter) (as described in example 8) was used.

Examples 26-45 show the preparation and mechanical strength of the experimental composites. In the examples described in the experimental composites, the dental resin is composed of 70 wt % BisGMA and 30 wt % TEGMA. Photo-initiators are 0.3 wt % camphorquinone and 0.8 wt % ethyl 4-dimethylamino benzoate based on dental resins. When modified OX-50 or pure OX-50 as filler, the composites contained 70 wt % dental resin and 30 wt % filler. When modified or unmodified 3000 Glass (with 0.7 μm average diameter), or Quartz (with 5.0 μm average diameter) are used as filler, the composites contained 30 wt % dental resin and 70 wt % filler. The mixture of dental resin and filler was mixed by hand. Un-modified OX-50, Quartz (with 5.0 μm average diameter), γ-methacryloxypropyltrimethoxysilane (γ-MPS) treated OX-50, and γ-MPS treated Quartz were provided by Confidental. Un-modified and γ-MPS (7 wt % γ-MPS) modified 3000 Glass were provided by Esstech. The stainless steel mold that provides a 2×2×25 mm opening was placed on a glass microscope slide. The composite paste obtained from the combined resin and filler was packed into the opening and a second glass slide is placed over the mold. The clamped assembly was then irradiated in three stages (center and each end) to convert the fluid composite paste to a solid polymer. The composite was cured for 3×40 s per side with VIP (Bisco) at 5×100 mW/cm². The VIP lamp was a standard dental photocuring unit with an irradiation output over the range 400-500 nm to allow visible light activation of commercial dental composites, adhesives and sealants. The polymerized composite specimen was ejected from the mold and the long axis surfaces were polished with silicon carbide paper prior to storage in distilled water at room temperature for 24 hours. The flexure strength was measured in the three-point bending mode using a MTS 858 Mini Bionix®II on eight specimens (approximately 25 mm×2 mm×2 mm).

TABLE 1
Mechanical Strength of composites containing 30 wt % OX-50 filler.

| | Filler | Modulus | | Strain at break |
|---|---|---|---|---|
| Composites | treatment | (MPa) | FS (MPa) | (%) |
| Example 26 | Pure | 3710 ± 200 | 92.7 ± 4.3 | 3.5 ± 0.5 |
| Example 27 | γ-MPS | 4180 ± 280 | 99.0 ± 6.5 | 2.9 ± 0.1 |
| Example 28 | Example 9 | 4130 ± 150 | 95.2 ± 9.7 | 3.0 ± 0.5 |
| Example 29 | Example 10 | 3880 ± 180 | 99.1 ± 3.5 | 3.5 ± 0.3 |
| Example 30 | Example 11 | 3570 ± 280 | 102.3 ± 8.1 | 4.8 ± 1.0 |
| Example 31 | Example 12 | 3610 ± 230 | 101.4 ± 4.5 | 4.7 ± 0.5 |
| Example 32 | Example 14 | 3930 ± 130 | 103.6 ± 5.4 | 3.9 ± 0.6 |
| Example 33 | Example 15 | 3550 ± 170 | 104.6 ± 5.9 | 5.2 ± 0.7 |
| Example 34 | Example 16 | 3610 ± 90 | 111.8 ± 4.2 | 5.3 ± 0.8 |
| Example 35 | Example 17 | 3920 ± 180 | 106.4 ± 8.7 | 3.9 ± 0.7 |
| Example 36 | Example 18 | 3190 ± 190 | 108.6 ± 3.8 | 5.5 ± 0.5 |
| Example 37 | Example 19 | 3070 ± 170 | 104.9 ± 4.3 | 5.6 ± 0.4 |
| Example 38 | Example 20 | 4090 ± 260 | 104.4 ± 5.4 | 3.8 ± 0.7 |

TABLE 2
Mechanical Strength of composites containing 70 wt %
E-3000 Glass filler.

| | | Modulus | | Strain at |
|---|---|---|---|---|
| Composites | Filler treatment | (MPa) | FS (MPa) | break (%) |
| Example 39 | γ-MPS (7 wt %) | 8940 ± 610 | 111.8 ± 12.7 | 1.5 ± 0.2 |
| Example 40 | Example 21 | 7110 ± 410 | 115.5 ± 10.0 | 2.3 ± 0.3 |
| Example 41 | Example 22 | 7900 ± 400 | 122.6 ± 6.0 | 2.1 ± 0.2 |

TABLE 3
Mechanical Strength of composites containing 70 wt % Quartz
(5.0 μm) filler.

| | | | | Strain at |
|---|---|---|---|---|
| Composites | Filler treatment | Modulus (MPa) | FS (MPa) | break (%) |
| Example 42 | γ-MPS | 11640 ± 430 | 126.9 ± 5.2 | 1.5 ± 0.1 |
| Example 43 | Example 23 | 9520 ± 480 | 139.2 ± 7.3 | 2.3 ± 0.3 |
| Example 44 | Example 24 | 9950 ± 470 | 139.6 ± 6.1 | 2.0 ± 0.2 |
| Example 45 | Example 25 | 9780 ± 650 | 133.4 ± 9.0 | 2.0 ± 0.2 |

From the above Tables 1-3, cured composites containing 30 wt % or 70 wt % polymer-brush modified filler (from 0.04 to 5 μm) have much improved mechanical properties than normal γ-MPS treated filler.

Example 46-50 shows the determination of maximum amount of filler loading. A mortar and pestle are used to mechanically blend the filler and resin with the maximum filler loading evidenced by heterogeneity in the paste. As shown in Example 46-50, both polymer-brush modified OX-50 (0.04 μm) and Quartz (5.0 μm) have higher filler loading than γ-MPS treated fillers. That means the modified OX-50 by the new method has dramatically better compatibility with dental monomers compared with the same filler treated by γ-MPS. Higher filler load will lead to lower volumetric shrinkage and potentially lower shrinkage stress.

TABLE 4
Maximum filler loading.

| Composites | Type of Filler | Filler treatment | Filler loading (wt %) |
|---|---|---|---|
| Example 46 | OX-50 (0.04 μm) | γ-MPS | 50.0 |
| Example 47 | OX-50 (0.04 μm) | Example 16 | 63.0 |
| Example 48 | OX-50 (0.04 μm) | Example 18 | 66.7 |
| Example 49 | Quartz (5.0 μm) | γ-MPS | 78.9 |
| Example 50 | Quartz (5.0 μm) | Example 23 | 79.5 |

FTIR Characterization of modified OX-50 Filler.

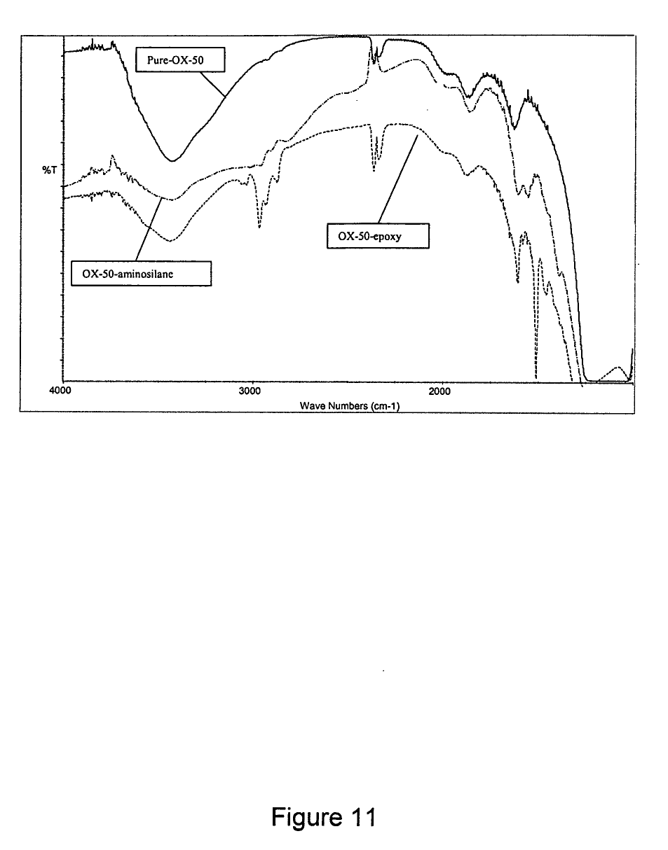

FIG. 11 shows the FTIR spectra of pure OX-50, OX-50 modified by 3-methylaminopropyl)trimethoxysilane and the amine-modified OX-50 further reacted with the epoxy resin.

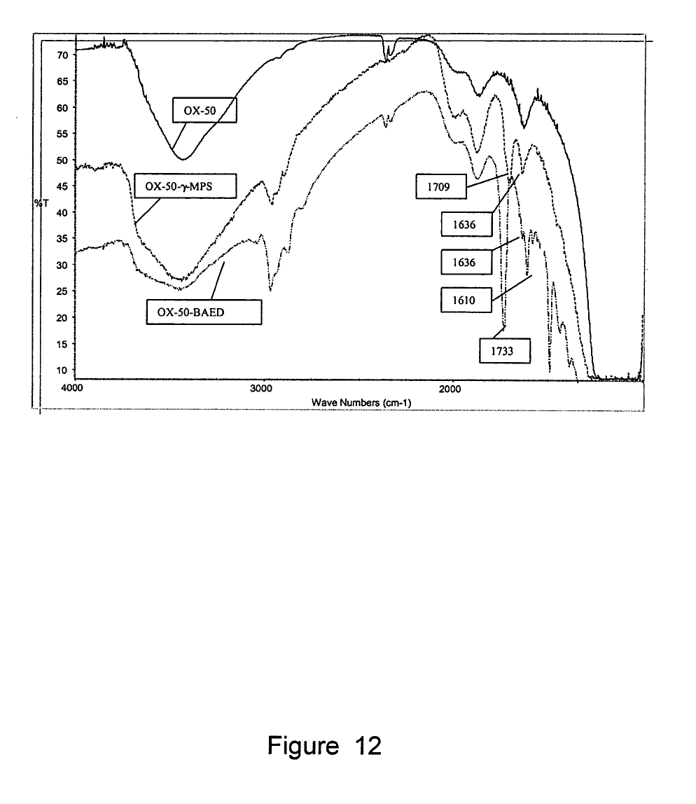

FIG. 12 shows the FTIR spectra of pure OX-50, γ-MPS modified OX-50 and bisphenol A ethyoxylate diacrylate (BAED) attached via the 3-methylaminopropyl)trimethoxysilane modified OX-50. The mid-FTIR with bands at 1610, 1636, 1733, and 2890-2968 cm-1 (assigned to aromatic C═C, aliphatic C═C, C═O and CH vibration, respectively) gives evidence of bisphenol A ethyoxylate diacrylate attaching to OX-50 via 3-methylaminopropyl)trimethoxysilane, and one functional group of acrylate in BAED still remains at the surface of the OX-50 filler.

Normally, higher monomer conversion has better mechanical strength and stability, but also has higher polymerization stress. However, we found that polymer-brush modified quartz filler (5.0 μm) have much higher final monomer conversion but also with lower polymerization stress compared to corresponding γ-MPS treated filler, as shown in example 54-55.

TABLE 5
Example 54-55 Monomer Conversion and Polymerization Stress.

| | | Filler | Filler | | Polymer- |
|---|---|---|---|---|---|
| Com- | Filler | Treat- | Content | Monomer | ization |
| posites | Type | ment | (wt %) | Conversion | Stress |
| Example | Quartz | γ-MPS | 70 | 56.9 ± 0.9 | 2.62 ± 0.05 |
| 54 | (5.0 μm) | | | | |
| Example | Quartz | Example | 70 | 72.20 ± 1.50 | 2.29 ± 0.03 |
| 55 | (5.0 μm) | 23 | | | |

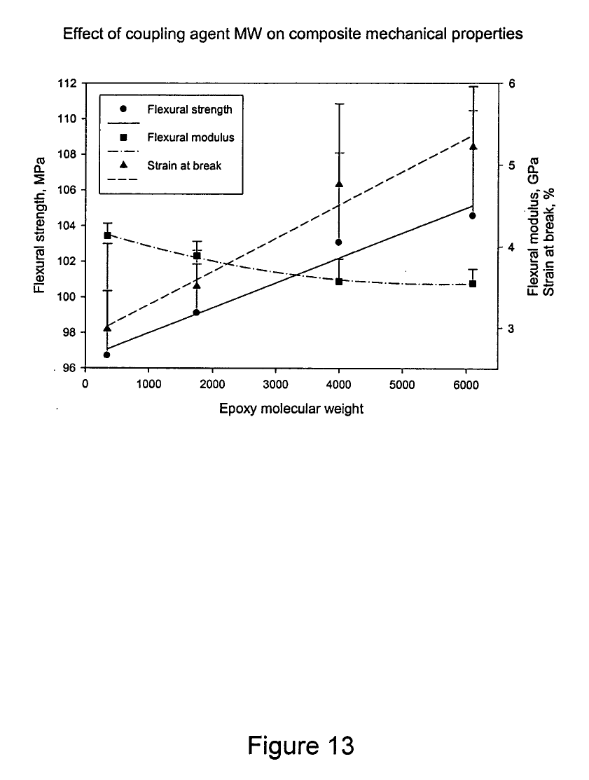

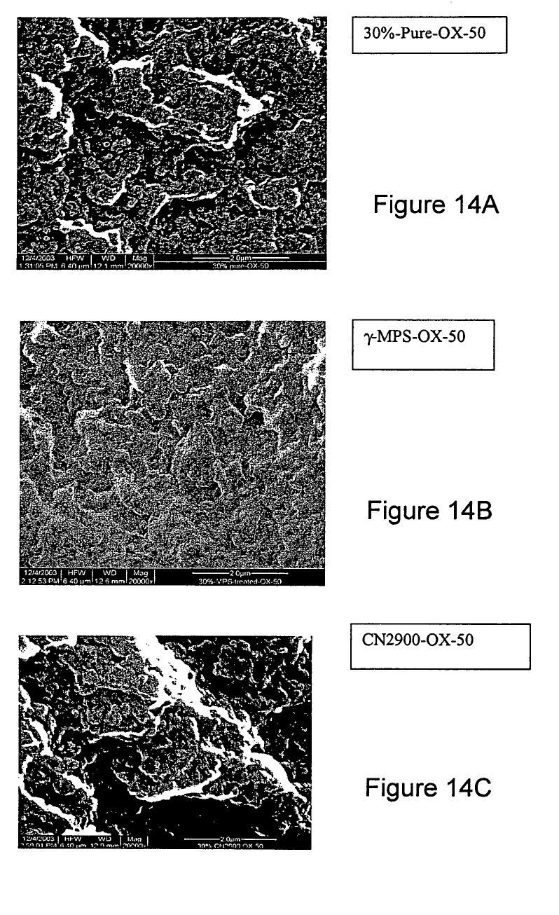

In the plots shown in FIG. 13, it was found that flexural strength and strain at break increased monotonically with the chain length of the epoxy polymer-modified filler. Mechanical properties of photocured composites based on bis-GMA/TEGDMA (7/3 wt) with 30% of epoxy polymer brush modified OX-50 filler. The molecular weight range of the epoxy chains varies from 348 to 6100 g/mol. A γ-MPS control was included for comparison. Specimens were stored in water 24 h prior to testing in a 3-point bending. The coupling agent prepared from the longest epoxide chain length produced a composite with a flexural strength that was statistically greater than that for the lowest epoxide molecular weight and greater than the control. The strain at break for the longest chain length was significantly greater than those for the shorter chains and the control material. Also, for the longest chain material, the modulus value was lower than the two with shorter chains and the control. This provides evidence that a composite with equivalent or better mechanical strength compared with conventional composite materials can be prepared while reducing the modulus. This has implications for reducing shrinkage stress development in dental composites. It should be noted that these results were obtained for a polymer brush coupling agent that does not contain any reactive group that can directly copolymerize with a methacrylate-based resin matrix. It relies on physical interactions between the matrix and coupling agent to reinforce the composite structure. It has also been demonstrated that the mechanical strength of the experimental composites can be improved further if (meth)acrylate groups are attached to the end of epoxy polymer brush, which would then be able to form chemical bonds with dental monomers during photopolymerization. After the measurement of flexural strength, scanning electron microscopy (SEM) was used to investigate the surface of fractured specimen and to evaluate the dispersion of microfiller into BisGMA/TEGMA resin matrix. FIGS. 14(A), 14(B) and 14(C) shows the SEM photographs of the fractured surface of composites prepared by using pure OX-50, γ-MPS treated OX-50 and polymer-brush modified OX-50, respectively. Compared to FIGS. 14(A) and 14(B), it can be easily to know that γ-MPS treatment can dramatically improve the dispersion of OX-50 filler in the resin matrix. It seems no much differences of the dispersion of the filler in the polymer matrix between FIGS. 14(B) and 14(C). However, for the same size of the dental composite sample, the fractured surface area of 14(C) is much higher that that of 14(B). Therefore the mechanical strength of the composite containing polymer-brush modified filler was greater improved.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the reactions used for treatment of the intermediate silanized surfaces in producing polymer brushes. Numerous other changes may be made which will readily suggest themselves to those skilled in the art and which are encompassed in the spirit of the invention disclosed and as defined in the appended claims. what is claimed is:

1. A polymer composition filler comprising at least one functional silane group of the formula —X—Y wherein
X is a silane; and
Y is a functional group independently selected from the group consisting of amine, anhydride, epoxy, hydroxyl, and sulfur functional groups;
wherein X is bonded to the surface of said filler.

2. The filler of claim 1, wherein X is selected from the group consisting of alkyltrialkoxysilane, aryltrialkoxysilane, alkyldialkoxysilane, trialkoxysilylalkylamide, trialkyloxysilylaryl, bis(trialkyloxyslyl alkyl), and (trialkoxysilylalkyl)-O-polyethylene oxide urethane.

3. The filler of claim 2, wherein X is selected from the group consisting of propyltriethoxysilane, propyltrimethoxysilane, bis(trimethoxysilylpropyl), trialkoxysilylalkylamide, trialkyloxysilylaryl, bis(trialkyloxyslyl alkyl), and N-(3-triethoxysilylpropyl)butyramide.

4. The filler of claim 1, wherein the functional silane group is selected from the group consisting of 3-aminopropyltriethoxysilane, N-methylaminopropyltrimethoxysilane, bis(trimethoxysilylpropyl)amine, and N-(3-triethoxysilylpropyl)-4-hydroxybutyramide.

5. A polymer-brush modified filler comprising at least one oligomer derivative of the formula —X—Y-Z-Z′ wherein
X is a silane;
Y is a functional group independently selected from the group consisting of amine, anhydride, epoxy, hydroxyl, and sulfur functional groups; and
Z-Z′ is a telechelic oligomer;
wherein Z is an oligomer; and
Z′ is a functional group independently selected from the group consisting of (meth)acrylate (—C(CH₃)═CH₂), epoxide, hydroxyl, COOH, —NH₂, —N(CH₃)H, and isocyanate functional groups;
wherein X is bonded to the surface of said filler.

6. The filler of claim 5, further comprising one or more non-functional silane groups, wherein the non-functional silane groups represent from about 1 to about 80 percent by weight of all silane groups.

7. The filler of claim 5, wherein the oligomer is a linear or branched polymer; comprising a molecular weight from about 300 to about 50,000 g/mol; and 2-18 functional groups.

8. The filler of claim 5, wherein each oligomer is independently selected from the group consisting of a polyurethane, epoxy resin, polybutadiene, siloxane, polyether, polyester, poly(styrene-co-butadiene), and poly[(meth)acrylate]polymeric backbone.

9. The filler of claim 5, wherein each oligomer is independently selected from the group consisting of bisphenol A ethyoxylate, bisphenol A glycerolate, bisphenol A propoxylate, bisphenol A propoxylate/ethoxylate, or bisphenol A propoxylate glycerolate, methacrylate, and urethane acrylate.

10. The filler of claim 5, wherein each telechelic oligomer is selected from the group consisting of glycidyl end-capped poly(bisphenol A-co-epichlorohydrin), isocyanatoethyl methacrylate, bisphenol A ethoxylate(1EO/phenol)diacrylate, urethane acrylate CN929, and urethane acrylate CN2900.

11. A method of making the polymer-brush modified filler of claim 5, comprising:
a. providing a filler;
b. silanizing the filler material with a silane; and
c. reacting the resulting silanized filler with at least one telechelic oligomer.

12. The method of claim 11, wherein the silane is a functional silane comprising at least one functional group independently selected from the group consisting of amine, anhydride, epoxy, hydroxyl, and sulfur functional groups.

13. The method of claim 11, wherein the silane is selected from functional silanes and non-functional silanes, wherein the non-functional silanes represent from about 1 to about 80 percent by weight of all silanes.

14. The method of claim 11, wherein step (b) is performed in the presence of a solvent selected from the group consisting of water, methyl alcohol, ethyl alcohol, propyl alcohol, isopropyl alcohol, butyl alcohol, cyclohexane, benzene, toluene, xylene and acetone.

15. The method of claim 11, wherein step (b) is performed within from about 0.5 to about 24 hours at a pH of from about 3 to about 9.

16. The method of claim 11, wherein step (b) is performed at a temperature of from about 15° C. to about 150° C.

17. The method of claim 11, further comprising subsequent to step (b), drying the silanized filler at a temperature of from about 20° C. to about 150° C., from about 2 hours to about 48.

18. A method of preparing a shaped dental prosthetic device comprising:
dispensing a mixture having at least one monomer and a polymer-brush modified filler of claim 5;
shaping the mixture; and
photopolymerizing the mixture.

19. A dental prosthetic device comprising:
a polymer created from the polymerization of at least one monomer; and
a polymer-brush modified filler of claim 5.

20. A photopolymerizable dental restorative material comprising:
a polymer-brush modified filler of claim 5;
at least one monomer having functional groups compatible with functional groups of the polymer-brush modified filler; and
an initiator.

21. A photopolymerizable dental restorative comprising:
a dispenser containing
a polymer-brush modified filler of claim 5;
at least one monomer having functional groups compatible with functional groups of the polymer-brush modified filler; and
an initiator.
